(19) United States
(12) Patent Application Publication
(10) Pub. No.: US 2026/0128924 A1
(43) Pub. Date: May 7, 2026

(54) METHOD AND SYSTEM FOR TIME BASED PERSONALIZATION MANAGEMENT IN MULTI-DEVICE ENVIRONMENT

(71) Applicant: Samsung Electronics Co., Ltd., Suwon-si (KR)

(72) Inventors: Sourabh TIWARI, Bengaluru (IN); Bhiman Kumar BAGHEL, Bengaluru (IN); Jalaj SHARMA, Bengaluru (IN); Manish CHAUHAN, Bengaluru (IN); Boddu Venkata Krishna VINAY, Bengaluru (IN); Syed Khaja MOINUDDIN, Bengaluru (IN)

(21) Appl. No.: 19/434,908

(22) Filed: Dec. 29, 2025

Related U.S. Application Data
(63) Continuation of application No. PCT/KR2024/007261, filed on May 28, 2024.

(30) Foreign Application Priority Data
Jul. 17, 2023 (IN) 202341048111
Nov. 22, 2023 (IN) 2023 41048111

(51) Int. Cl. H04L 12/28

(52) U.S. Cl. CPC H04L 12/282; H04L 12/2807

(57) ABSTRACT

A method performed by a user device of time based personalization management in a multi-device environment is provided. identifying, by the user device based on a first user input, at least one smart device among a plurality of smart devices for performing a first action corresponding to the first user input determining, by the user device in response to the first user input, one or more context information associated with a user corresponding to the user input, the multi-device environment, and the at least one smart device, predicting, by the user device using a prediction model, a relevant time span for the identified at least one smart device until which a context of the first user input is required to be preserved, and integrating, by the user device, the predicted relevant time span with the identified at least one smart device.

### CROSS-REFERENCE TO RELATED APPLICATION(S)

This application is a continuation application, claiming priority under 35 U.S.C. § 365 (c), of an International application No. PCT/KR2024/007261, filed on May 28, 2024, which is based on and claims the benefit of an Indian Provisional patent application No. 202341048111, filed on Jul. 17, 2023, in the Indian Intellectual Property Office, and of an Indian Complete patent application No. 202341048111, filed on Nov. 22, 2023, in the Indian Intellectual Property Office, the disclosure of each of which is incorporated by reference herein in its entirety.

### BACKGROUND

### 1. Field

The disclosure relates to a field of Internet of Things (IoT). More particularly, the disclosure relates to a method and system for time based personalization management in a multi-device environment.

### 2. Description of Related Art

In past years, development of wireless communication technologies such as Bluetooth and wireless fidelity (Wi-Fi) laid groundwork for an expansion of Internet of Things (IoT). These technologies enabled seamless connectivity between devices and opened up new possibilities for IoT applications. Further, with increasing use of smartphones and accessibility of fast mobile data networks, the IoT gained traction in recent years. This allowed users to remotely control and monitor their devices through mobile apps, giving rise to a concept of multi-device IoT environments such as smart homes.

In the IoT, the multi-device environment refers to a network of interconnected devices in which the multi-device environment facilitates automation, intelligence, and control of the interconnected devices to provide an immersive experience to the users. In a non-limiting example, the interconnected devices may correspond, but are not limited, to smartphones, tablets, laptops, desktop computers, smartwatches, televisions (TVs), Air Conditioners (ACs), lights, curtains, remotes, and other connected devices.

In a conventional multi-device environment, a user may require one or more identical devices among the interconnected devices in different rooms of a smart home to fulfil his/her requirement. In a non-limiting example, the user may require the AC in a bedroom and a living room of the smart home. In another non-limiting example, the user may require the TV in the bedroom as well as in the living room. Thus, if the user provides ambiguous user input to a virtual assistant to control operations on any of the one or more identical devices, then the virtual assistant is unable to take action on an intended device within the smart home. Thus, the virtual assistant may require follow-up queries to overcome ambiguity on the user input. Subsequently, the user may provide another ambiguous user input to control different operations of the intended device. In this scenario, the virtual assistant may again be required to follow up with the user to overcome the ambiguity in another ambiguous user input. Thus, such conventional multi-device environment faces challenges in processing ambiguous user inputs and hence not compatible with handling the above-mentioned problem scenario.

FIG. 1 illustrates an example scenario of a conventional multi-device environment, according to the related art.

Referring to FIG. 1, a user 102 provides a user input to the virtual assistant of a user device 104 to control an intended device in the multi-device environment. A precondition for the scenario corresponds to the multi-device environment comprising two TVs, in which a first TV is installed in the bedroom and a second TV is installed in the living room. Further, operations 106 to 120 of FIG. 1 in combination illustrates the problem of subsequent follow-up queries with the user in the multi-device environment. In operation 106, the user provides user input to the virtual assistant (i.e., Bixby) to turn on the TV. As two identical devices are installed at home, the virtual assistant of the user device 104 is unable to recognize the intended TV to turn on. Thus, to overcome the ambiguity, in operation 108, the virtual assistant provides a follow-up query, i.e., “which TV would you like to turn on?”. In operation 110, the user provides the user input to turn on the living room TV. In response, the user device 104 facilitates the multi-device environment to turn on the living room TV and provides feedback to the user in operation 112. Subsequently, in operation 114, the user provides another user input for raising the TV volume. As the user provides a subsequent input command to raise the TV volume followed by an input command to turn on the living room TV, then in this scenario, the virtual assistant of the user device 104 may relate the subsequent input command to the living room TV. This happens because the virtual assistant of the user device 104 does not consider historical context while processing the subsequent input command. According to the state-of-the-art solution, there is a challenge to store the historical context due to various issues. For example, not having enough memory to store the historical context or a time period for storing the historical context has expired and the like. Thus, in operation 116, the virtual assistant of the user device 104 provides another follow-up query to the user to confirm which TV volume needs to be increased. Furthermore, in operation 118, the user confirms that the living room TV volume needs to be increased. Thereafter, in operation 120, the virtual assistant of the user device 104 confirms to increase the living room TV volume based on the user confirmation. Thus, the conventional approach as disclosed in FIG. 1 faces challenges in processing ambiguous user inputs and hence not compatible to handle the user commands that are ambiguous in nature. It results in an increase in user inconvenience and frustration in providing multiple answers to the follow-up queries being asked by the virtual assistant of the user device 104.

FIG. 2 is another example scenario of the multi-device environment, according to the related art. A precondition for the scenario corresponds to that the multi-device environment comprises two TVs and two ACs, in which the first TV and a first AC are installed in the main room. Further, the second TV and a second AC are installed in the living room.

Referring to FIG. 2, in operation 202, the user provides user input to the virtual assistant (i.e., Bixby) to turn on the AC. To overcome the ambiguity of the two identical devices, in operation 204, the virtual assistant provides a follow-up query, i.e., which AC would you like to turn on? In operation 206, the user provides the user input to turn on the living room AC. In response, the user device 104 facilitates the multi-device environment to turn on the living room AC and provides feedback to the user in operation 208. Subsequently, in operation 210, the user provides another user input to turn on the TV. As the user provides a command to turn on the living room AC, thus, the subsequent user input to turn on the TV should relate to the living room TV. As the multi-device environment fails to capture historical context and the time period for which the context is relevant, thus, in operation 212, the virtual assistant of the user device 104 provides another follow-up query to confirm which TV needs to be turned on according to the related art. In operation 214, the user confirms that the living room TV needs to be turned on. Further, in operation 216, the user device 104 confirms upon facilitating the multi-device environment to turn on the living room TV.

FIG. 3 is another example scenario of the multi-device environment, according to the related art. A precondition for the scenario corresponds to the multi-device environment comprising two TVs, in which the first TV is installed in the bedroom and the second TV is installed in the living room.

Referring to FIG. 3, operations 302 to 316 are similar to operations 106 to 120. Thus, an explanation of operations 302, 304, 306, 308, 310, 312, 314 and 316 is omitted herein for the sake of brevity with respect to the explanation of operations 106, 108, 110, 112, 114, 116, 118 and 120. Further, in operation 318, the user provides the user input to the virtual assistant (i.e., Bixby) to turn on the bedroom TV. In operation 320, the user device 104 confirms to the user that the bedroom TV is on upon facilitating the multi-device environment to turn on the bedroom TV. Further, in operation 322, the user provides another user input to raise the TV volume. However, as the instruction is ambiguous, in operation 324, the virtual assistant of the user device 104 provides another follow-up query to confirm the intended TV on which the TV volume needs to be increased. In operation 326, the user provides the user input that the TV volume of the bedroom TV needs to be increased. Further, in operation 328, the user device 104 confirms to the user that the TV volume of the bedroom TV is increased. Thus, in accordance with the example scenario shown in FIG. 3, the user needs to provide the user input twice to increase the TV volume as shown at operations 310 and 322. This also results in the increase in the user inconvenience and frustration level of the user in providing multiple answers to the follow-up queries being asked by the virtual assistant of the user device 104.

Therefore, it would be advantageous to provide an improved method and system that can overcome challenges, limitations, and the above-mentioned problems associated with the multi-device environment having multiple IoT enabled devices according to the related art.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and system for time based personalization management in a multi-device environment.

Additional aspects will be set forth in part in the description which follows and, in part, will be apparent from the description, or may be learned by practice of the presented embodiments.

In accordance with an aspect of the disclosure, a method performed by a user device of time based personalization management in a multi-device environment is provided. The method includes identifying, by the user device based on a first user input, at least one smart device among a plurality of smart devices in the multi-device environment for performing a first action corresponding to the first user input, determining, by the user device in response to the first user input, one or more context information associated with a user corresponding to the user input, the multi-device environment, and the identified at least one smart device, predicting, by the user device using a prediction model based on the determined one or more context information, a relevant time span for the identified at least one smart device until which a context of the first user input is required to be preserved. and integrating, by the user device, the predicted relevant time span with the identified at least one smart device for performing the first action corresponding to the first user input.

In accordance with another aspect of the disclosure, a multi-device system for time based personalization management in a multi-device environment is provided. The multi-device system includes a plurality of smart devices configured to communicate with each other in the multi-device environment, a user device including memory, comprising one or more storage media, storing instructions, and at least one processor and configured with a virtual assistant, the user device is communicatively coupled with each of the plurality of smart devices via the virtual assistant, and the memory, wherein the instructions, when executed by at least one processor individually or collectively, cause the user device to identify, based on a first user input, at least one smart device among a plurality of smart devices in the multi-device environment for performing a first action corresponding to the first user input, determine in response to the first user input, one or more context information associated with a user corresponding to the first user input, the multi-device environment, and the identified at least one smart device, predict, using a prediction model, based on the determined one or more context information, a relevant time span for the identified at least one smart device until which a context of the first user input is required to be preserved, and integrate the predicted relevant time span with the identified at least one smart device for performing the first action corresponding to the first user input.

In accordance with another aspect of the disclosure, one or more non-transitory computer-readable storage media storing one or more computer programs including computer-executable instructions that, when executed by one or more processors of a user device in a multi-device environment individually or collectively, cause the user device to perform operations are provided. The operations include identifying, by the user device based on a first user input, at least one smart device among a plurality of smart devices in the multi-device environment for performing a first action corresponding to the first user input, determining, by the user device in response to the first user input, one or more context information associated with a user corresponding to the first user input, the multi-device environment, and the identified at least one smart device, predicting, by the user device using a prediction model based on the determined one or more context information, a relevant time span for the identified at least one smart device until which a context of the first user input is required to be preserved, and integrating, by the user device, the predicted relevant time span with the identified at least one smart device for performing the first action corresponding to the first user input.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example scenario of a multi-device environment, according to the related art;

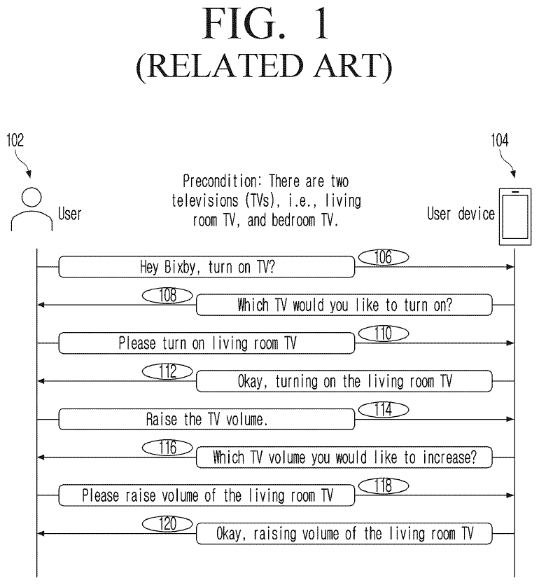

FIG. 2 illustrates another example scenario of a multi-device environment, according to the related art;

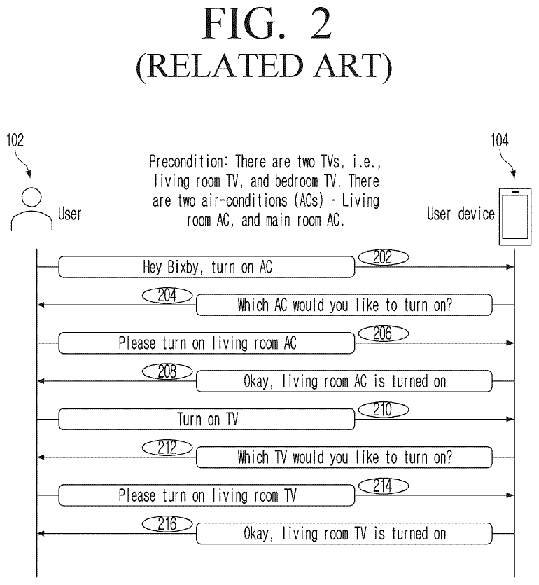

FIG. 3 illustrates yet another example scenario of a multi-device environment, according to the related art;

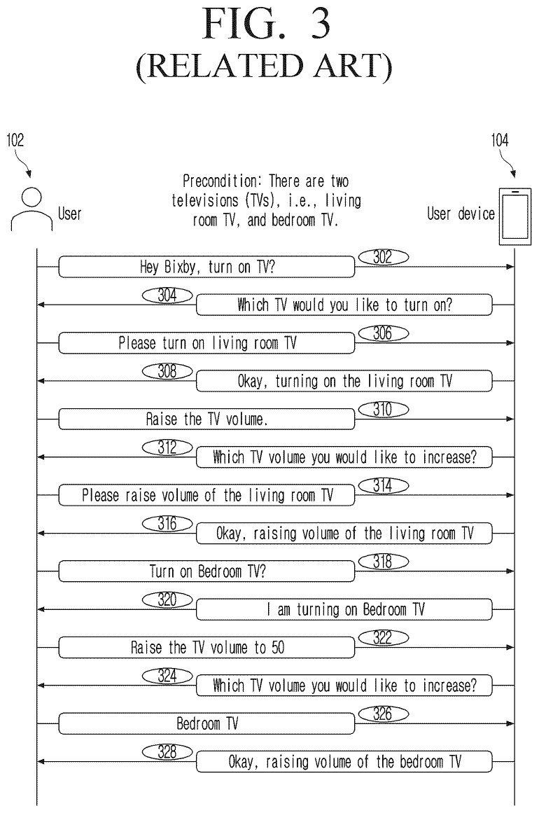

FIG. 4 illustrates a schematic block diagram of a multi-device system for time based personalization management in a multi-device environment, according to an embodiment of the disclosure;

FIG. 5 illustrates a schematic block diagram of a module as illustrated in FIG. 4, according to an embodiment of the disclosure;

FIG. 6 illustrates a dynamic relevance time predictor module of FIG. 5 based on an Artificial Intelligence (AI) model, according to an embodiment of the disclosure;

FIG. 7 illustrates a flow chart of a method for time based personalization management in a multi-device environment, according to an embodiment of the disclosure;

FIG. 8 illustrates a scenario depicting a time based personalization in a multi-device environment, according to an embodiment of the disclosure;

FIG. 9 illustrates another scenario depicting a time based personalization in a multi-device environment, according to an embodiment of the disclosure;

FIG. 10 illustrates yet another scenario depicting a time based personalization in a multi-device environment, according to an embodiment of the disclosure; and

FIG. 11 illustrates an example scenario depicting a time based personalization based on a rule-based model, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments f the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “some” or “one or more” as used herein is defined as “one”, “more than one”, or “all.” Accordingly, the terms “more than one,” “one or more” or “all” would all fall under the definition of “some” or “one or more”. The terms “an embodiment”, “another embodiment”, “some embodiments”, or “in one or more embodiments” may refer to one embodiment or several embodiments, or all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents. The phrase “exemplary” may refer to an example.

More specifically, any terms used herein such as but not limited to “includes,” “comprises,” “has,” “consists,” “have” and grammatical variants thereof do not specify an exact limitation or restriction and certainly do not exclude the possible addition of one or more features or elements, unless otherwise stated, and must not be taken to exclude the possible removal of one or more of the listed features and elements unless otherwise stated with the limiting language “must comprise” or “needs to include”.

Whether or not a certain feature or element was limited to being used only once, either way, it may still be referred to as “one or more features”, “one or more elements”, “at least one feature”, or “at least one element.” Furthermore, the use of the terms “one or more” or “at least one” feature or element does not preclude there being none of that feature or element unless otherwise specified by limiting language such as “there needs to be one or more” or “one or more element is required.”

Unless otherwise defined, all terms, and especially any technical and/or scientific terms, used herein may be taken to have the same meaning as commonly understood by one having ordinary skill in the art.

Now embodiments of the disclosure will be described below in detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

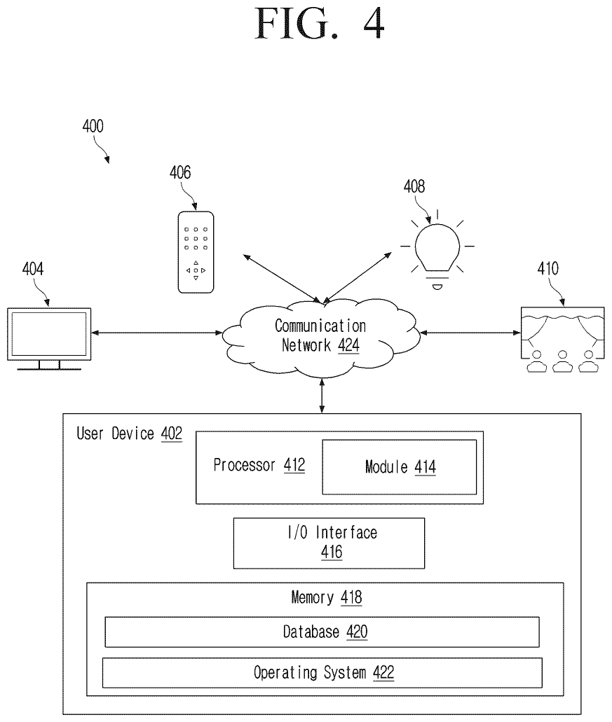

FIG. 4 illustrates a schematic block diagram of a multi-device system 400 for time based personalization management in a multi-device environment, according to an embodiment of the disclosure.

Referring to FIG. 4, the multi-device system 400 includes a user device 402, and a plurality of smart devices configured to communicate with each other in the multi-device environment through a communication network 424. Each smart device among the plurality of smart devices corresponds to an electronic device that can connect to an internet connection and perform various tasks, such as controlling various operations of home appliances, monitoring energy consumption, and so on. The plurality of smart devices may be controlled by the user device 402. According to another embodiment, the plurality of smart devices can also integrate each other to create a connected and automated smart home environment or IoT environment. In a non-limiting example, the plurality of smart devices comprises but is not limited to, a TV 404, a remote controller 406, a light source 408, and a blind 410. The blind 410 typically refers to window coverings made of fabric or vinyl that can be adjusted to control light and privacy.

In an embodiment, the user device 402 may correspond to, but is not limited to, a smartphone, other mobile devices, a laptop, a tablet, a computer, etc.

According to an embodiment, the user device 402 comprises at least one processor 412 (hereinafter referred to as the processor 412), an Input/Output (I/O) interface 416, and memory 418. The processor 412, the I/O interface 416, and the memory 418 are communicatively coupled with each other. The processor 412 comprises one or more modules 414 (hereinafter referred to as the module 414) for performing operations for time based personalization management in the multi-device environment.

According to an embodiment, the processor 412 may be operatively coupled to the module 414 for processing, executing, or performing a set of operations. In another embodiment, the processor 412 may include at least one data processor for executing processes in a Virtual Storage Area Network. The processor 412 may include specialized processing units such as integrated system (bus) controllers, memory management control units, floating point units, graphics processing units, digital signal processing units, etc. In yet another embodiment, the processor 412 may include a central processing unit (CPU), a graphics processing unit (GPU), or both. The processor 412 may be one or more general processors, digital signal processors, application-specific integrated circuits, field-programmable gate arrays, servers, networks, digital circuits, analog circuits, combinations thereof, or other now known or later developed devices for analyzing and processing data. The processor 412 may execute one or more instructions, such as code generated manually (i.e., programmed) to perform one or more operations disclosed herein throughout the disclosure.

According to an embodiment, the term “module” or “modules” used herein may imply a unit including, for example, one of hardware, software, and firmware or a combination of two or more of them. The “module” or “modules” may be interchangeably used with a term such as logic, a logical block, a component, and the like. The “module” or “modules” may be a minimum device component for performing one or more functions or maybe a part thereof. The processor 412 may control the module 414 to execute a specific set of operations as described below in the forthcoming paragraphs of the disclosure.

According to an embodiment, the I/O interface 416 refers to hardware or software components that enable data communication between the user device 402 and any other devices or systems. The I/O interface 416 serves as a communication medium for exchanging information, commands, or data with the other devices or systems. According to another embodiment, the I/O interface 416 may be a part of the processor 412 or maybe a separate component. The I/O interface 416 may be created in software or maybe a physical connection in hardware. The I/O interface 416 may be configured to connect with an external network, external media, the display, or any other components, or combinations thereof. The external network may be a physical connection, such as a wired Ethernet connection, or may be established wirelessly. In a non-limiting example, the user device 402 may be configured to receive one or more user inputs for performing one or more desired operations as forthcoming paragraphs of the disclosure. The one or more user inputs may be alternatively disclosed as a first user input, a second user input, and so on throughout the disclosure without deviating from the scope of the disclosure. The first user input may correspond to any one of a voice input of a user, a text input, a Graphical User Interface (GUI) input, a remote-control input, and a gesture input. Further, the second user input corresponds to any one of the voice input of the user, the text input, and the gesture input that causes disambiguation. According to an alternate embodiment, the first user input may cause disambiguation when receiving input from any one of the voice inputs of the user, the test input, the GUI input, and the gesture input. However, the first user input may not cause disambiguation when received through the remote control input.

According to an embodiment, the memory 418 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 418 is communicatively coupled with the processor 412 to store bitstreams or processing instructions for completing one or more processes. Further, the memory 418 includes an operating system 422 for performing one or more tasks of the user device 402, as performed by a generic operating system in the communications domain. Furthermore, the memory 418 includes a database 420 to store the information as required by the module 414 and the processor 412 to perform one or more functions for time based personalization management in the multi-device environment. Further, the memory 418 may store one or more values, such as, but not limited to, one or more intermediate data generated by the module 414, parameters required for the module 414, threshold values, etc. Furthermore, the memory 418 may store one or more models for performing operations as disclosed throughout the disclosure.

According to an embodiment, the communication network 424 refers to any entity that performs one or more functionalities of a network connection between the user device 402 and the plurality of smart devices. Further, the network connection may be established between the user device 402 and the plurality of smart devices via a communication port or interface or using a bus (not shown). The communication port may be configured to connect with a network, external media, memory, or any other components in a system, or combinations thereof. The network connection may be a physical connection, such as a wired Ethernet connection, or may be established wirelessly. Likewise, the additional connections with other components of the multi-device system 400 may be physical or may be established wirelessly.

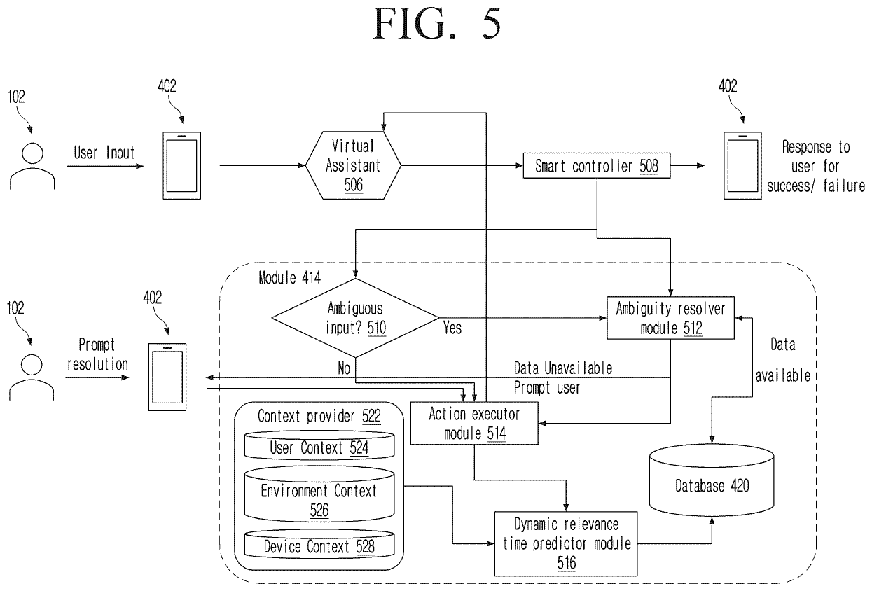

FIG. 5 illustrates a schematic block diagram of the module 414 as illustrated in FIG. 4, according to an embodiment of the disclosure.

Referring to FIG. 5, the module 414 includes an ambiguity resolver module 512, an action executor module 514, and a dynamic relevance time predictor module 516. The module 414 communicates with the user device 402, a virtual assistant 506, and a smart controller 508 to perform a set of operations for time based personalization management in the multi-device environment. According to an embodiment, the virtual assistant 506 may be also called an Artificial Intelligence (AI) assistant or digital assistant. The smart controller 508 may correspond to a controller in the multi-device environment to control the operations of at least one smart device among the plurality of smart devices. According to another embodiment, the virtual assistant 506 and the smart controller 508 may also be a part of the user device 402. However, the virtual assistant 506 and the smart controller 508 are disclosed in FIG. 5 as different components for ease of explanation without deviating from the scope of the disclosure. In a non-limiting example, the virtual assistant 506 may relate to, but may not be limited to, Siri, Bixby, and so on.

According to an embodiment, the user device 402 receives a first user input from a user 102. The virtual assistant 506 receives the first user input from the user device 402. Further, the smart controller 508 receives the first user input from the virtual assistant 506 to perform the operation on an intended user device. Thereafter, the module 414 receives the first user input from the smart controller 508. Subsequently, the module 414 determines whether the first user input is an ambiguous user input or a partial user input via a decision block 510 for performing a first action by the at least one smart device. The ambiguous user input or the partial user input relates to a user input that does not specifically define an intended at least one smart device among the plurality of smart devices to perform any action. For example, if the multi-device environment includes two identical devices, such as two TVs, then the user 102 provides the ambiguous user input or the partial user input as “turn on the TV” without specifically disclosing which TV needs to be turned on. Based on a determination by the decision block 510, if the first user input is the ambiguous user input, then a flow moves to the ambiguity resolver module 512. Based on the determination by the decision block 510, if the first user input is not ambiguous, then the flow moves to the action executor module 514.

According to an embodiment, the at least one smart device has same functionality with respect to a set of smart devices among the plurality of smart devices. In a non-limiting example, the TV and a speaker among the plurality of smart devices have the same functionality of increasing and decreasing volume. Thus, the multi-device system 400 is configured to identify the at least one smart device among the set of smart devices to perform the first action corresponding to the first user input.

According to an embodiment, based on the first user input, the ambiguity resolver module 512 identifies at least one smart device among the plurality of smart devices in the multi-device environment for performing the first action corresponding to the first user input. The ambiguity resolver module 512 determines whether corresponding data is available in the database 420 for performing the first action. If the corresponding data is unavailable, to overcome the ambiguity, the ambiguity resolver module 512 initiates a prompt to the user for resolution of the ambiguity. For example, if the first user input relates to “turn on the TV” without specifying which TV needs to be turned on, then the ambiguity resolver module 512 prompts the user “which TV you would like to turn on?”. Based on a prompt resolution response, the action executor module 514 controls the virtual assistant 506 for performing the first action corresponding to the first user input and the prompt resolution response. Alternatively, if the corresponding data is available in the database 420, the ambiguity resolver module 512 fetches an unambiguous data from the database 420 and sends the unambiguous data to the action executor module 514 for performing the first action.

According to an embodiment, if the action executor module 514 provides input to the virtual assistant 506 after identifying the at least one smart device in the multi-device environment to perform the first action based on the first user input. The action executor module 514 provides input to the virtual assistant 506 after resolving ambiguity either from the prompt resolution or from the database 420 via the ambiguity resolver module 512. Alternatively, if there is no ambiguity in the first user input, then the action executor module 514 provides input to the virtual assistant 506 to perform the first action based on the first user input. In addition, the action executor module 514 triggers the dynamic relevance time predictor module 516 to predict a relevant time span for the identified at least one smart device. The action executor module 514 triggers the dynamic relevance time predictor module 516 in two conditions. A first condition among the two conditions corresponds to when the ambiguity occurs for a first time and there is no data available for the relevant time span in the database 420. A second condition among the two conditions corresponds to when an update is required in previously stored data in the database 420 to revise the relevant time span for a corresponding at least one smart device.

According to an embodiment, in response to the first user input, the dynamic relevance time predictor module 516 determines one or more context information associated with a user, the multi-device environment, and the identified at least one smart device. Thus, the dynamic relevance time predictor module 516 determines the one or more context information by retrieving information from a context provider 522 associated with the user, multi-device environment, and the at least one smart device. The dynamic relevance time predictor module 516 retrieves context information from a context of the user 524. Further, the dynamic relevance time predictor module 516 retrieves context information from a context of environment in the multi-device environment 526. In addition, the dynamic relevance time predictor module 516 retrieves context information from an operational context of the identified at least one smart device 528. A context provider 522 comprises the context of the user 524, the context of environment in the multi-device environment 526, and the operational context of the identified at least one smart device 528. The context provider 522 may relate to a database for storing corresponding one or more context information. In a non-limiting example, the context of the user 524 includes historical user interactions with the plurality of smart devices in the multi-device environment. Further, the dynamic relevance time predictor module 516 determines the one or more context information by retrieving information from the context of the user 524.

According to an embodiment, the dynamic relevance time predictor module 516 assigns a dynamic weightage to each of the context of the user 524, the context of environment in the multi-device environment 526, and the operational context of the identified at least one smart device 528. In a non-limiting example, in case, the user has not used any user input for an entire day, then the operational context of the identified at least one smart device 528 may become dominant based on an assigned dynamic weightage. In another non-limiting example, if the user has recently provided the user input on the TV, then the context of the user 524 and the operational context of the identified at least one smart device 528 become dominant.

In a non-limiting example, the context of the user 524 relates to information about the user's historical activity on the at least one smart device by the first user input. An example of the context of the user 524 is shown in Table 1 below. As shown in Table 1, the context of the user 524 includes a historical user context such as the first user input from the user. Further, the context of the user 524 includes an executed device identification (ID), a voice intent of the user, and a relevant time span (old). In a non-limiting example, as shown in row number 1 of Table 1, the historical user context corresponds to “Turn on living room TV”. The dynamic relevance time predictor module 516 identifies the device ID of the “living room TV”. Thereafter, based on the historical user context, the dynamic relevance time predictor module 516 recognizes an intent of the user, i.e., to turn on the device. Thus, based on the intent of the user, the relevant time span (old) is predicted earlier.

TABLE 1

| | Executed | | |
|---|---|---|---|
| User ontext | Device ID (Label | Voice Intent | Relevant time |
| (History) | Encoding) | (Label Encoding) | span (Old) |
| 1. Turn on living | Living room TV | Device-turnOn | Living room TV |
| room TV | (03) | (01) | (03) (10 mins) |
| 2. Raise the TV | Living room TV | Volume-increase | Living room TV |
| volume | (03) | (05) | (03) (7 mins) |
| 3. Changechannel | Living room TV | Channel- | Living room TV |
| to HBO | (03) | setByName(09) | (03) (8 mins) |
| . . . | | | |

In another non-limiting example, the context of environment in the multi-device environment 526 relates to an environment of the plurality of smart devices. An example of the context of environment in the multi-device environment 526 is shown in Table 2 below. As shown in Table 2, the context of environment in the multi-device environment 526 corresponds to time as 7 PM, day as Saturday, location as living room, and season as summer. Further, the dynamic relevance time predictor module 516 identifies corresponding label encoding of the environment context. As an example, the label encoding corresponds to encoded labels of the voice intents, a device location, the device ID, and an environment context such as time of day, day, etc. The label encoding is provided as the input into the AI model.

TABLE 2

| | | Label |
|---|---|---|
| Environment Context | | Encoding |
| Time | 7 PM | [03] |
| Day | Saturday | [06] |
| Location | Living room | [03] |
| Season | Summer | [04] |
| . . . | | |

In yet another non-limiting example, the operational context of the identified at least one smart device 528 relates to an operational context of the at least one smart device. An example of the operational context of the identified at least one smart device 528 is shown in Table 3 below. As shown in Table 3, the operational context of the TV in the living room relates to an “On” state, and “Home” channel. Further, state of the AC is “On” for “Cool” mode.

TABLE 3
Device Context

| | |
|---|---|
| Living Room | TV:{“State”: ”On”, |
| | “Channel”: ”Home”}AC: |
| | {“State”: ”On”, “Mode”: |
| | ”Cool”} |
| Bedroom | AC:{“State”: ”Off”} |
| | Lights: {“State”: ”Off”} |
| | TV: {“State”: ”Off”} |

According to an embodiment, the dynamic relevance time predictor module 516 further predicts a relevant time span using a prediction model based on the determined one or more context information. The relevant time span is predicted for the identified at least one smart device until which a context of the first user input is required to be preserved.

According to an embodiment, the dynamic relevance time predictor module 516 predicts the relevant time span from the information retrieved from the context provider 522 and thereby stores the relevant time span in the database 420.

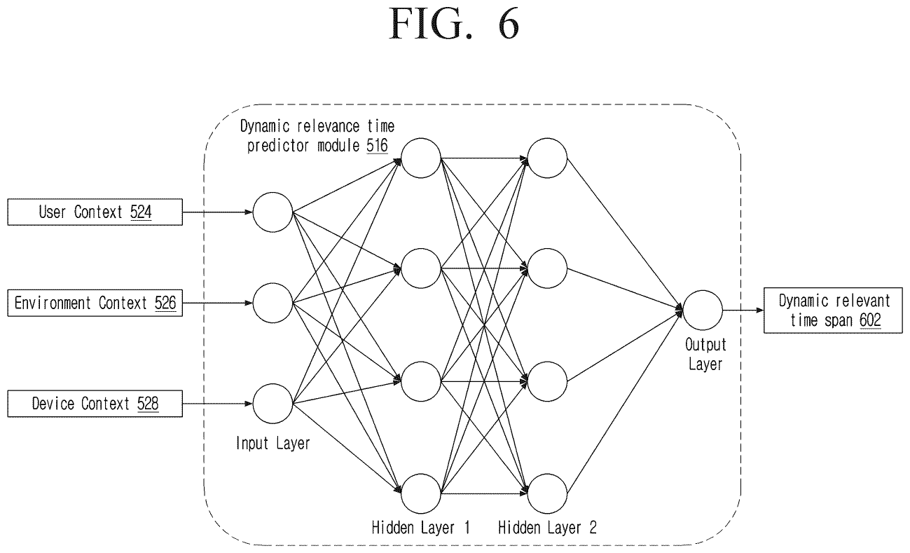

According to an embodiment, the prediction model may correspond to an AI model for predicting the relevant time span based on the first user input. The AI model is trained to predict the relevant time span for the identified at least one smart device based on the determined one or more context information. FIG. 6 illustrates the dynamic relevance time predictor module of FIG. 5 based on the AI model, according to an embodiment of the disclosure. An input layer of the AI model receives input from the context of the user 524, the context of environment in the multi-device environment 526, and the operational context of the identified at least one smart device 528. Based on the received input, the AI model dynamically determines the relevant time span 602 by utilizing at least two hidden layers, such as layer 1, and layer 2. An example of the relevant time span 602 is shown in Table 4 below. As shown in Table 4, the relevant time span 602 for the Living room TV is set for 7 minutes. Thus, for any subsequent ambiguous user input within 7 minutes relating to the TV, the multi-device system 400 resolves the ambiguity by performing actions on the living room TV. Further, the relevant time span 602 changes sequence based on the remaining time period. Further, an entry that appears in row 1 gets the highest priority if any ambiguity happens between entries present in the relevant time span 602. For example, the relevant time span 602 of the living room TV is 7 minutes, and the relevant time span 602 of the bedroom TV is 3 minutes. In this scenario, the multi-device system 400 considers the ambiguous user input relating to “raise the TV volume” as “raise the living room TV volume” as the relevant time span 602 of the living room TV is more than the bedroom TV. The relevant time span 602 may be stored in the database 420 for subsequent use by the ambiguity resolver module 512.

TABLE 4
Relevant time span

| | |
|---|---|
| Living room TV | 7 min |
| Living room AC | 2 min |
| Hall light | 0 min |
| . . . | . . . |

In a non-limiting example, the dynamic relevance time predictor module 516 predicts the relevant time span 602 of the blind 410 based on the context of environment in the multi-device environment 526. If the context of environment in the multi-device environment 526 relates to cloudy weather, then the relevant time span 602 for the blind 410 may be set as 25 minutes. Alternatively, if the context of environment in the multi-device environment 526 relates to sunny weather, then the relevant time span 602 for the blind 410 may be set as 15 minutes. The relevant time span 602 is longer for cloudy weather because the user may provide a second user input within a longer period of time than in sunny weather.

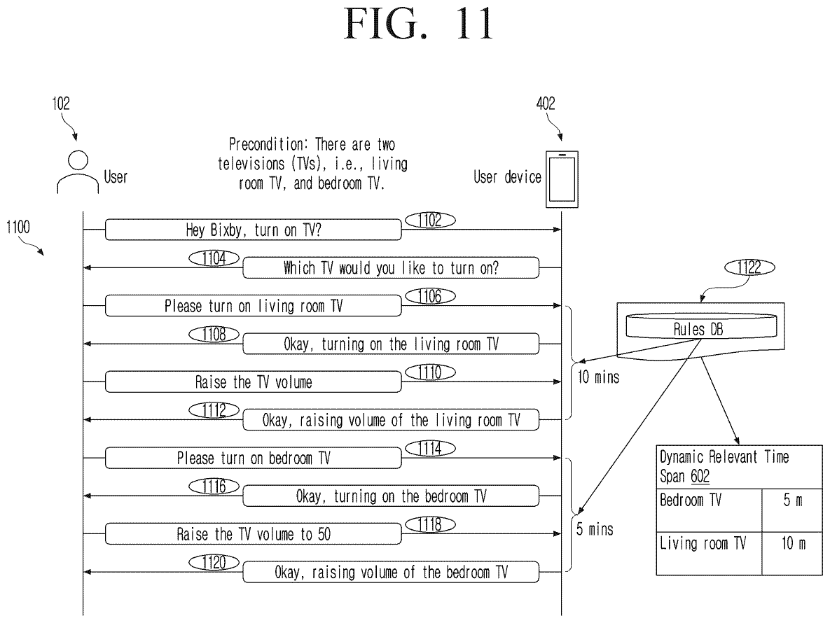

According to an embodiment, the prediction model corresponds to a rule-based model for predicting the relevant time span based on the first user input. In the rule-based model, a priority is assigned to at least one smart device which is last used for performing an action corresponding to the user input. For example, the action executor module 514 controls the TV volume of the living room TV according to the user input. Therefore, the relevant time span 602 is set as 10 minutes (10 minutes is considered as default time) for the living room TV. Subsequently, if the user input relates to “turn on the bedroom TV”. Thus, the relevant time span 602 is set as 5 minutes (that is less than the default time set for an earlier instance) for the bedroom TV. Further, the bedroom TV is set as the highest priority. Therefore, the action executor module 514 considers the bedroom TV for any ambiguous user input relating to the TV in the next 5 minutes. A scenario for the rule-based model for predicting the relevant time span is illustrated in FIG. 11.

According to an embodiment, the dynamic relevance time predictor module 516 integrates the predicted relevant time span with the identified at least one smart device for performing the first action corresponding to the first user input. Thus, the relevant time span is stored in database 420 for the identified at least smart device for performing the first action.

According to an embodiment, the ambiguity resolver module 512 determines whether a second user input is received subsequently after the first user input within the predicted relevant time span. If the second user input is ambiguous and received within the predicted relevant time span, the action executor module 514 controls the identified at least one smart device to perform a second action. In a non-limiting example, the relevant time span 602 of the living room TV is set as 10 minutes. If the second user input is received within 10 minutes and the second user input is ambiguous, then the ambiguity resolver module 512 determines the “living room TV” for performing the second action.

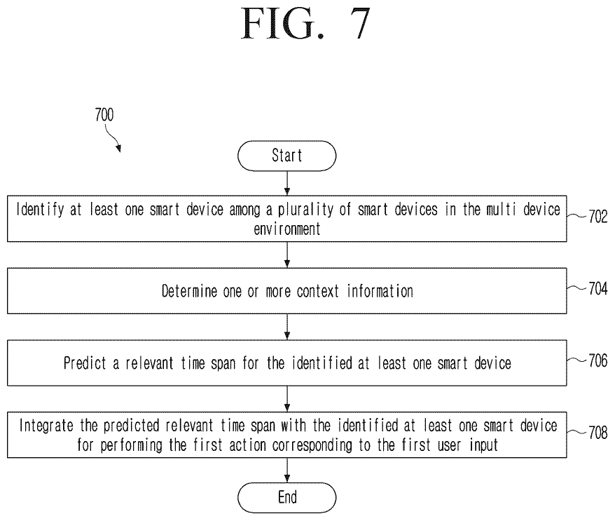

FIG. 7 illustrates a flow chart of a method 700 for time based personalization management in the multi-device environment, according to an embodiment of the disclosure.

Referring to FIG. 7, the method 700 includes a series of operations 702 through 708 for time based personalized management. The details of the method 700 have been explained below in forthcoming paragraphs. The order in which the method operations are described below is not intended to be construed as a limitation, and any number of the described method operations can be combined in any appropriate order to execute the method or an alternative method. Additionally, individual operations may be deleted from the method without departing from the scope of the disclosure. The method operation 700 begins from a start block and starts execution of operations in operation 702, as shown in FIG. 7.

In operation 702, the method 700 comprises identifying, based on the first user input, at least one smart device among the plurality of smart devices in the multi-device environment for performing the first action corresponding to the first user input. The ambiguity resolver module 512 identifies at least one smart device for performing the first action. The first user input may relate to the ambiguous user input. Thus, the ambiguity resolver module 512 identifies at least one smart device by resolving ambiguity based on either the prompt resolution or from the database 420. The flow of the method 700 now proceeds to operation 704.

In operation 704, in response to the first user input, the method 700 determines one or more context information associated with the user corresponding to the first user input, the multi-device environment, and the identified at least one smart device. The dynamic relevance time predictor module 516 determines one or more context information. The context information is determined to predict the relevant time span 602. The flow of the method 700 now proceeds to operation 706.

In operation 706, the method 700 comprises predicting, using the prediction model, the relevant time span for the identified at least one smart device until which the context of the first user input is required to be preserved. The dynamic relevance time predictor module 516 predicts the relevant time span for the identified at least one smart device. The flow of the method 700 now proceeds to operation 708.

In operation 708, the method 700 comprises integrating the predicted relevant time span with the identified at least one smart device for performing the first action corresponding to the first user input. Particularly, the dynamic relevance time predictor module 516 integrates the predicted relevant time span with the identified at least one smart device. Thus, the relevant time span is stored in database 420 for the identified at least smart device for performing the first action.

It is to be noted that the method operations 702 through 708 and other operations disclosed herein are performed by the processor 412 of the user device 402.

While the above-discussed operations in FIG. 7 are shown and described in a particular sequence, the operations may occur in variations to the sequence in accordance with various embodiments. Further, a detailed description related to the various operations of FIG. 7 is already covered in the description related to FIGS. 4 to 6 and is omitted herein for the sake of brevity.

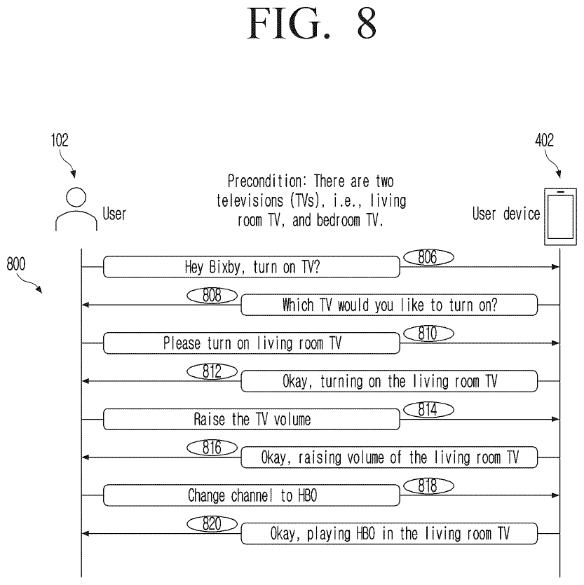

FIG. 8 illustrates an example scenario depicting a time based personalization in the multi-device environment, according to an embodiment of the disclosure.

According to an example embodiment, a sequence of operations 800 is depicted in a line diagram. Referring to FIG. 8, the user 102 provides the user input to the virtual assistant 506 of the user device 402 to control the intended device in the multi-device environment. A precondition for the scenario corresponds to the multi-device environment comprising two TVs, in which a first TV is installed in the bedroom and a second TV is installed in the living room. In operation 806, the user provides the first user input to the virtual assistant 506 (for example, Bixby) to turn on the TV. As the relevant time span 602 is not present in the database 420 and two identical devices are installed at home, the ambiguity resolver module 512 is unable to recognize the intended TV to turn on. Thus, to overcome the ambiguity, in operation 808, the user device 402 provides the prompt resolution query, i.e., which TV would you like to turn on? In operation 810, the user responds to the prompt resolution query to turn on the living room TV. In response, the action executor module 514 facilitates the multi-device environment to turn on the living room TV and provides feedback to the user in operation 812. In addition, the dynamic relevance time predictor module 516 identifies the relevant time span 602 for the identified at least one smart device, i.e., for the living room TV. In operation 814, the user 102 provides the second user input for raising the TV volume within the relevant time span 602. Thus, the action executor module 514 facilitates raising the TV volume of the living room TV in operation 816 without prompting the user to resolve ambiguity. Similarly, in operation 818, the user 102 provides a third user input to change a channel to HBO within the relevant time span 602. Thus, the action executor module 514 facilitates playing the HBO channel in the living room TV in operation 820 without prompting the user to resolve ambiguity. Thus, the disclosure improves user experience and reduces time to facilitate appropriate action corresponding to the user input.

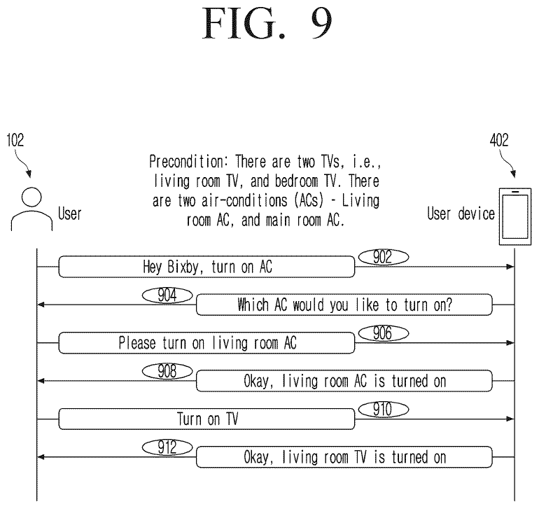

FIG. 9 illustrates another example scenario depicting a time based personalization in the multi-device environment, according to an embodiment of the disclosure.

A precondition for another scenario corresponds to that the multi-device environment comprises two TVs and two ACs, in which the first TV and a first AC are installed in the main room. Further, the second TV and a second AC are installed in the living room. Referring to FIG. 9, in operation 902, the user provides the first user input to the virtual assistant 506 (i.e., Bixby) to turn on the AC. The relevant time span 602 is not available in the database 420, thus, the ambiguity resolver module 512 is unable to overcome the ambiguity of the two identical devices. Therefore, in operation 904, the virtual assistant 506 provides the prompt resolution query, i.e., “which AC would you like to turn on?”. In operation 906, the user responds to the prompt resolution query to turn on the living room AC. Subsequently, the dynamic relevance time predictor module 516 predicts the relevant time span 602 with respect to one or more context information and saves the relevant time span 602 in the database 420. In response, the action executor module 514 facilitates the multi-device environment to turn on the living room AC and provides feedback to the user in operation 908. Subsequently, in operation 910, the user provides the second user input to turn on the TV within the predicted relevant time span 602. In operation 912, the action executor module 514 facilitates the multi-device environment to turn on the living room TV without prompting the prompt resolution query. Thus, the disclosure reduces further operations to save time and energy for the user device 402.

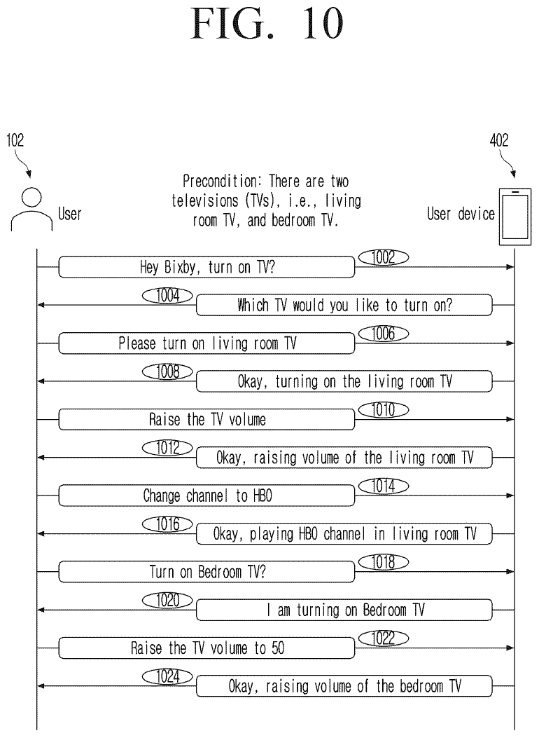

FIG. 10 illustrates yet another example scenario depicting a time based personalization in the multi-device environment, according to an embodiment of the disclosure.

A precondition for yet another scenario corresponds to that the multi-device environment comprises two TVs, in which the first TV is installed in the bedroom and the second TV is installed in the living room. Operations 1002 to 1016 are similar to operations 806 to 820. Thus, an explanation of operations 1002, 1004, 1006, 1008, 1010, 1012, 1014 and 1016 is omitted herein for the sake of brevity with respect to the explanation of operations 806, 808, 810, 812, 814, 816, 818 and 820. Further, in operation 1018, the user provides a fourth user input to the virtual assistant 506 (i.e., Bixby) to turn on the bedroom TV. The fourth user input is unambiguous user input. Thus, in operation 1020, the action executor module 514 facilitates the multi-device environment to turn on the bedroom TV and thereby provides feedback to the user 102. In addition, the dynamic relevance time predictor module 516 predicts the relevant time span 602 for the bedroom TV based on the one or more context information. Further, in operation 1022, the user provides a fifth user input to raise the TV volume within the relevant time span 602. Further, in operation 1024, the action executor module 514 facilitates raising the TV volume of the bedroom TV based on the relevant time span 602 and confirms to the user that the TV volume of the bedroom TV is raised. Thus, the disclosure enhances user experience by dynamically determining the relevant time span 602 based on latest user input.

FIG. 11 illustrates an example scenario depicting a time based personalization based on the rule-based model, according to an embodiment of the disclosure.

Referring to FIG. 11, a precondition for yet another scenario 1100 corresponds to that the multi-device environment comprises two TVs, in which the first TV is installed in the bedroom and the second TV is installed in the living room. Operations 1102, 1104, 1106, 1108, 1110 and 1112 are similar to operations 806, 808, 810, 812, 814 and 816. Thus, an explanation of operations 1102 to 1112 is omitted herein for the sake of brevity with respect to the explanation of operations 806 to 816. However, the rule-based model sets the priority to the living room TV during operations of operations 1106 to 1112 as the living room TV is last used for performing the action corresponding to the user input. Further, the relevant time span 602 is set as 10 minutes for the living room TV based on rules defined in a rules database 1122. Thus, in operation 1110, when the user provides a third user input for raising the TV volume within the relevant time span 602 of 10 minutes, the action executor module 514 facilitates raising the TV volume of the living room TV in operation 1112 without prompting the user to resolve ambiguity. Further, in operation 1114, the user provides a fourth user input to the virtual assistant 506 (i.e., Bixby) to turn on the bedroom TV. The fourth user input is unambiguous user input. Thus, in operation 1116, the action executor module 514 facilitates the multi-device environment to turn on the bedroom TV and thereby provides feedback to the user 102. In addition, the rule-based model sets highest priority to the bedroom TV that is last used for performing the action corresponding to the fourth user input. Further, the relevant time span 602 is set as 5 minutes for the bedroom TV based on rules defined in the rules database 1122. Furthermore, in operation 1118, the user provides a fifth user input, which is ambiguous, to raise the TV volume within the relevant time span 602 of 5 minutes from the fourth user input with bedroom TV having the highest priority. Further, in operation 1120, the action executor module 514 facilitates raising the TV volume of the bedroom TV based on the priority, the relevant time span 602 and thereby confirms to the user that the TV volume of the bedroom TV is raised. Thus, the disclosure enhances user experience by dynamically determining the relevant time span 602 based on the rule-based model.

Referring now to the technical abilities and effectiveness of the method 700 and multi-device system 400 as disclosed herein. The following technical advantages over the conventional and existing solutions are provided. The method 700 as disclosed herein above helps in improving user experience by eliminating the prompt resolution query if any subsequent ambiguous user input is provided within the relevant time span 602. In addition, the relevant time span 602 is predicted dynamically based on personalized context, i.e., the one or more context information. The method 700 determines priority of the at least one smart device among the plurality of smart devices according to the capabilities and wait/listening time in order to get the most relevant smart device in case of disambiguation. Further, the method 700 reduces overall execution time by storing the relevant time span 602 to eliminate a device disambiguation scenario. Furthermore, the disclosure saves energy of the user device 402 as a number of prompt resolution queries is decreased.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user device of time based personalization management in a multi-device environment, the method comprising:
identifying, by the user device based on a first user input, at least one smart device among a plurality of smart devices in the multi-device environment for performing a first action corresponding to the first user input;
determining, by the user device in response to the first user input, one or more context information associated with a user corresponding to the first user input, the multi-device environment, and the identified at least one smart device;
predicting, by the user device using a prediction model based on the determined one or more context information, a relevant time span for the identified at least one smart device until which a context of the first user input is required to be preserved; and
integrating, by the user device, the predicted relevant time span with the identified at least one smart device for performing the first action corresponding to the first user input.

2. The method of claim 1, further comprising:
determining whether a second user input is received subsequently after the first user input within the predicted relevant time span; and
controlling, based on a determination that the second user input is received subsequently after the first user input within the predicted relevant time span, the identified at least one smart device to perform a second action.

3. The method of claim 1, wherein identifying the at least one smart device among the plurality of smart devices comprises:
determining whether the first user input is an ambiguous user input for performing the first action by the at least one smart device; and
identifying the at least one smart device in the multi-device environment based on a determination that the first user input is the ambiguous user input.

4. The method of claim 1, wherein determining the one or more context information comprises:
determining a context of the user, a context of environment in the multi-device environment, and an operational context of the identified at least one smart device, wherein the context of the user is determined based on historical user interactions with the plurality of smart devices in the multi-device environment; and
determining the one or more context information based on the context of the user, the context of environment in the multi-device environment, and the operational context of the identified at least one smart device.

5. The method of claim 4, further comprising assigning a dynamic weightage to each of the determined context of the user, the context of the multi-device environment, and the operational context of the identified at least one smart device.

6. The method of claim 1, wherein the prediction model corresponds to a rule-based model for predicting the relevant time span based on the first user input.

7. The method of claim 1,
wherein the prediction model corresponds to an artificial intelligence (AI) model for predicting the relevant time based on the first user input, and
wherein the AI model is trained to predict the relevant time span for the identified at least one smart device based on the determined one or more context information.

8. The method of claim 1,
wherein the multi-device environment corresponds to one of a smart home environment or an internet of things (IoT) environment, and
wherein the at least one smart device has same functionality with respect to a set of smart devices among the plurality of smart devices.

9. The method of claim 2,
wherein the first user input corresponds to any one of a voice input of a user, a text input, a graphical user interface (GUI) input, a remote-control input, or a gesture input, and
wherein the second user input corresponds to any one of the voice input of the user, the text input, or the gesture input that causes disambiguation.

10. A multi-device system for time based personalization management in a multi-device environment, the multi-device system comprising:
a plurality of smart devices configured to communicate with each other in the multi-device environment; and
a user device including:
memory, comprising one or more storage media, storing instructions, and
at least one processor and configured with a virtual assistant, the user device is communicatively coupled with each of the plurality of smart devices via the virtual assistant, and the memory,
wherein the instructions, when executed by the at least one processor individually or collectively, cause the user device to:
identify, based on a first user input, at least one smart device among the plurality of smart devices in the multi-device environment for performing a first action corresponding to the first user input,
determine, in response to the first user input, one or more context information associated with a user corresponding to the first user input, the multi-device environment, and the identified at least one smart device,
predict, using a prediction model based on the determined one or more context information, a relevant time span for the identified at least one smart device until which a context of the first user input is required to be preserved, and
integrate the predicted relevant time span with the identified at least one smart device for performing the first action corresponding to the first user input.

11. The multi-device system of claim 10, wherein the instructions when executed by at least one processor individually or collectively further cause the user device to:
determine whether a second user input is received subsequently after the first user input within the predicted relevant time span; and
control, based on a determination that the second user input is received subsequently after the first user input within the predicted relevant time span, the identified at least one smart device to perform a second action.

12. The multi-device system of claim 10, wherein to identify the at least one smart device among the plurality of smart devices, the instructions when executed by at least one processor individually or collectively further cause the user device to:
determine whether the first user input is an ambiguous user input for performing the first action by the at least one smart device; and
identify the at least one smart device in the multi-device environment based on a determination that the first user input is the ambiguous user input.

13. The multi-device system of claim 10, wherein to determine the one or more context information, the instructions when executed by at least one processor individually or collectively further cause the user device to:
determine a context of the user, a context of environment in the multi-device environment, and an operational context of the identified at least one smart device, wherein the context of the user is determined based on historical user interactions with the plurality of smart devices in the multi-device environment; and
determine the one or more context information based on the context of the user, the context of environment in the multi-device environment, and the operational context of the identified at least one smart device.

14. The multi-device system of claim 13, wherein the instructions when executed by at least one processor individually or collectively further cause the user device to assign a dynamic weightage to each of the determined context of the user, the context of the multi-device environment, and the operational context of the identified at least one smart device.

15. The multi-device system of claim 13, wherein, based on the user device having not received any user input for a given period of time, the operational context of the identified at least one smart device is set to a dominant state based on the assigned dynamic weightage of the operational context of the identified at least one smart device.

16. The multi-device system of claim 15, wherein, when the user has recently provided the user input a given smart device, the context of the user and the operational context of the identified at least one smart device is set to the dominant state.

17. One or more non-transitory computer-readable storage media storing one or more computer programs including computer-executable instructions that, when executed by one or more processors of a user device in a multi-device environment individually or collectively, cause the user device to perform operations, the operations comprising:
identifying, by the user device based on a first user input, at least one smart device among a plurality of smart devices in the multi-device environment for performing a first action corresponding to the first user input;
determining, by the user device in response to the first user input, one or more context information associated with a user corresponding to the first user input, the multi-device environment, and the identified at least one smart device;
predicting, by the user device using a prediction model based on the determined one or more context information, a relevant time span for the identified at least one smart device until which a context of the first user input is required to be preserved; and
integrating, by the user device, the predicted relevant time span with the identified at least one smart device for performing the first action corresponding to the first user input.

18. The one or more non-transitory computer-readable storage media of claim 17, the operations further comprising:
determining whether a second user input is received subsequently after the first user input within the predicted relevant time span; and
controlling, based on a determination that the second user input is received subsequently after the first user input within the predicted relevant time span, the identified at least one smart device to perform a second action.

19. The one or more non-transitory computer-readable storage media of claim 17, wherein identifying the at least one smart device among the plurality of smart devices comprises:
determining whether the first user input is an ambiguous user input for performing the first action by the at least one smart device; and
identifying the at least one smart device in the multi-device environment based on a determination that the first user input is the ambiguous user input.

20. The one or more non-transitory computer-readable storage media of claim 17, wherein determining the one or more context information comprises:
determining a context of the user, a context of environment in the multi-device environment, and an operational context of the identified at least one smart device, wherein the context of the user is determined based on historical user interactions with the plurality of smart devices in the multi-device environment; and
determining the one or more context information based on the context of the user, the context of environment in the multi-device environment, and the operational context of the identified at least one smart device.
